(19) United States
(12) Patent Application Publication
(10) Pub. No.: US 2012/0089871 A1
(43) Pub. Date: Apr. 12, 2012

(54) TEST SYSTEM

(75) Inventor: Yu-Liang SUN, Taipei City (TW)

(73) Assignee: INVENTEC CORPORATION, TAIPEI CITY (TW)

(21) Appl. No.: 13/026,306

(22) Filed: Feb. 14, 2011

(30) Foreign Application Priority Data
Oct. 11, 2010 (TW) 099134610

(51) Int. Cl. G06F 11/263

(52) U.S. Cl. 714/32; 714/E11.177

(57) ABSTRACT

A test system includes at least one tested end and a testing end. The testing end establishes a connection with the tested end. A plurality of predetermined hardware model numbers and a plurality of predetermined hardware configuration files corresponding to the predetermined hardware model numbers are stored at the testing end. The testing end determines if a tested hardware model number of the tested end is one of the predetermined hardware model numbers. When the tested hardware model number is one of the predetermined hardware model numbers, a tested hardware configuration file corresponding to the tested hardware model number is obtained from the predetermined hardware configuration files. The testing end generates at least one test item for the tested end in accordance with the tested hardware configuration file. The testing end performs the at least one test item on the tested end.

### RELATED APPLICATIONS

This application claims priority to Taiwan Application Ser. No. 099134610, filed Oct. 11, 2010, which is herein incorporated by reference.

### BACKGROUND

1. Field of Invention

The present invention relates to a test system.

2. Description of Related Art

With the advance of information technologies, the applications of computer hardware devices are more and more popular. The computer hardware devices include a display card for enabling a screen to display data; a sound card for enabling a computer to output sounds; and a network card for connecting to a network. For example, the network card is a communication bridge between a computer host and Internet. Without the network card, the computer host cannot be linked to Internet

When the computer hardware devices are fabricated, a set of test methods is required to test the functions and performance of the computer hardware devices. For example, for testing a network card, a tester has to first activate the network card, and then to conform whether a host computer can be linked to Internet successfully and to check the time required for linking to the Internet, thereby verifying the functions and performance of the network card.

When testing the computer hardware devices, a conventional skill first has to detect the hardware configuration files of the computer hardware devices, such as a CPU (Central Processing Unit) model number and its supported error detecting and correcting methods, or other hardware-related configuration files. However, the step of detecting hardware configuration often results in the slow turn-on of the computer hardware device, thus needing longer test time.

### SUMMARY

Hence, an aspect of the present invention is to provide a test system for performing a test on a tested end in accordance with a hardware configuration file which has been stored in the tested end, without needing to detect again the hardware configuration of the tested end. The test system includes at least one tested end and a testing end. The tested end has a tested hardware model number. A connection is established between the testing end and the tested end. The testing end includes a hardware function table, a model-determining module, a configuration-obtaining module, a test generation module and a test execution module. In the hardware function table, a plurality of predetermined hardware model numbers and a plurality of predetermined hardware configuration files corresponding to the predetermined hardware model numbers are stored. The model-determining module determines if the tested hardware model number of the tested end is one of the predetermined hardware model numbers. When the tested hardware model number is one of the predetermined hardware model numbers, the configuration-obtaining module obtains a tested hardware configuration file corresponding to the tested hardware model number from the predetermined hardware configuration files. The test generation module generates at least one test item for the tested end in accordance with the tested hardware configuration file. The test execution module performs the at least one test item on the tested end.

According to an embodiment, the testing end may further include a hardware detection module for detecting the tested end when the tested hardware model number is not one of the predetermined hardware model numbers, thereby obtaining the tested hardware configuration file of the tested end. Further, the testing end may include a configuration-writing module for writing the tested hardware configuration file obtained by the hardware detection module into the hardware function table.

According to another embodiment, the testing end may further include a web page providing module for providing a test web page, wherein the test execution module may periodically return current test information to web page providing module when the at least one test item is performed on the tested end, thereby allowing the web page providing module to display the current test information on the test web page. Further, the test generation module may provide a plurality of selectable test items to the web page providing module, and the web page providing module may display the selectable test items on the test web page, thereby generating a selection signal via the test web page for selecting at least one of the selectable test items as the at least one test item for the tested end.

According to another embodiment, the testing end may further include a test result database and a test result generation module. The test result generation module generates a test result after the at least one test item has

### BRIEF DESCRIPTION OF THE DRAWINGS

These and other features, aspects, and advantages of the present invention will become better understood with regard to the following description, appended claims, and accompanying drawings where:

FIG. 1 is a functional block diagram showing a test system according to an embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

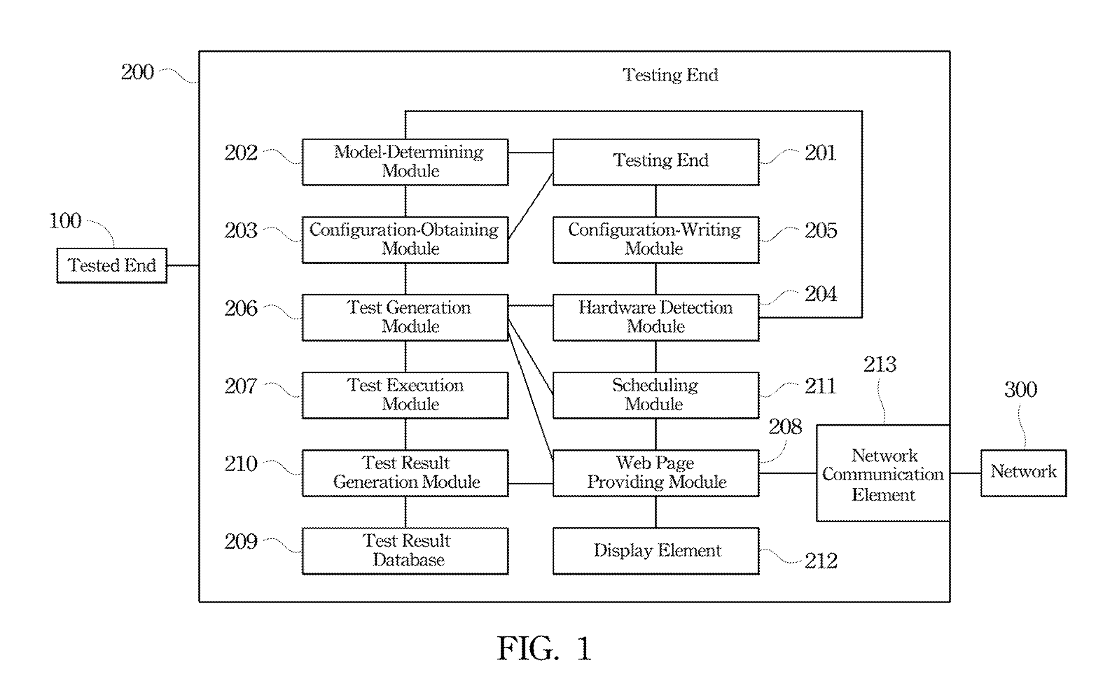

Referring to FIG. 1, FIG. 1 is a functional block diagram showing a test system according to an embodiment of the present invention. When a hardware configuration file of a tested end has been stored in a testing end of a test system, the testing performs a test on the tested end in accordance with the existing hardware configuration file of the tested end without needing to detect again the hardware configuration of the tested end.

The test system includes at least one tested end 100 and a testing end 200, wherein a connection is established between the testing end 200 and the tested end 100. The tested end 100 can be a computer hardware device or another electronic device. The testing end 200 can be a device different from the tested end 100. Further, the testing end 200 also can be a test program installed in the tested end 100. The tested end 100 has a tested hardware model number. The testing end 200 includes a hardware function table 201, a

Moreover, when the tested hardware model number does not exist in the hardware function table 201, the hardware configuration of the tested end 100 is detected. Thus, the testing end 200 may further include a hardware detection module 204 used for detecting the tested end 100 when the tested hardware model number is not one of the predetermined hardware model numbers, thereby obtaining the tested hardware configuration file of the tested end 100. Therefore, the test generation module 206 may generate test items in accordance with the tested hardware configuration file detected, thereby allowing the test execution module 207 to perform test on the tested end 100. Consequently, even if the (tested) hardware configuration file of the tested end 100 does not exist in the hardware function table 201, the testing end 200 still can perform a test on the tested end 100. Further, the testing end 200 may include a configuration-writing module 205 used for writing the tested hardware configuration file obtained by the hardware detection module 204 into the hardware function table 201. Accordingly, when the same device of the tested end 100 needs testing again, the testing end 200 may perform a test in accordance with the hardware configuration file which has been written into the hardware function table 201.

The testing end 200 may provide a web page for displaying test information or providing test-related operations. The testing end 200 may further include a web page providing module 208 used for providing a test web page, wherein the test web page provided by the web page providing module 208 can be displayed on a display element 212 of the testing end 200. Further, the test web page provided by the web page providing module 208 can be transmitted to a network 300 via a network communication element 213 of the been performed on the tested end, and stores the test result into the test result database.

According to another embodiment, the testing end may further include a scheduling module for scheduling the test items for the tested end when there are more than one test items, thereby generating a test item sequence for the tested end, and thus the test execution module performs the test items on the tested end according to the test item sequence.

It can be known from the aforementioned embodiments that the application of the present invention has the following advantages. When having been stored in the hardware function table, a tested end's hardware configuration file located in a hardware function table and corresponding to a tested hardware model number can be directly based to perform a test on the tested end, thus saving the time for detecting the tested end's hardware configuration file. Further, when not being stored in the hardware function table, the tested end's hardware configuration file still can be detected for use as a base for testing the tested end. Moreover, a test web page can be used to display test information or to provide test-related operations, wherein, since a web page has high compatibility and is easily transmitted via network, the test web page can be displayed at a host of a testing end or transmitted to a remote end.

It is to be understood that both the foregoing general description and the following detailed description are examples, and are intended to provide further explanation of the invention as claimed. model-determining module 202, a configuration-obtaining module 203, a test generation module 206 and a test execution module 207. In the hardware function table 201, a plurality of predetermined hardware model numbers and a plurality of predetermined hardware configuration files corresponding to the predetermined hardware model numbers are stored, wherein the predetermined hardware configuration files may include a CPU model number and its supported error detecting and correcting methods, or other hardware-related configuration files.

The model-determining module 202 determines if the tested hardware model number of the tested end 100 is one of the predetermined hardware model numbers stored in the hardware function table 201. When the tested hardware model number is one of the predetermined hardware model numbers, the configuration-obtaining module 203 obtains a tested hardware configuration file corresponding to the tested hardware model number from the predetermined hardware configuration files stored in the hardware function table 201. The test generation module 206 generates at least one test item for the tested end 100 in accordance with the tested hardware configuration file. The test execution module 207 performs the at least one test item on the tested end 100. Consequently, under the condition without needing to detect again the hardware configuration file of the tested end 100, a test can be performed on the tested end 100, thus saving the time for detecting the hardware configuration file of the tested end 100. Besides, a test which is not supported by hardware configuration file of the tested end 100 can be prevented from being performed thereon, thus further saving testing time. testing end 200. Consequently, a user may obtain the test web page at a remote end via the network 300. Moreover, since the web page has high compatibility and can be executed on various operating systems or various platforms, it does not need to be modified with different operating systems or platforms used for performing the test.

Further, when the at least one test item is performed on the tested end 100, the test execution module 207 may periodically return current test information to web page providing module 208, so that the web page providing module 208 may display the current test information on the test web page, wherein the current test information includes current test progress, completed test items, completed test item results or other test-related information.

Further, the test generation module 206 may provide a plurality of selectable test items to the web page providing module 208, and the web page providing module 208 may display the selectable test items on the test web page. Accordingly, a user may select at least one of the selectable test items as the at least one test item for the tested end 100 via the test web page, thereby generating a selection signal. Consequently, the user can select the test items desirable to be performed on the tested 100 via the test web page.

The testing end 200 may store test results in a database for inquiry. Thus, the testing end 200 may further include a test result database 209 and a test result generation module 210. The test result generation module 210 generates a test result after the at least one test item has been performed on the tested end 100, and stores the test result into the test result database 209, wherein the test result generated by the test result generation module 210 can be a log file. Consequently, the user is able to inquire the test result file stored in the test result database 209, thereby learning the test result of the tested end 100. Particularly, when a plurality of tested ends have been tested, their test results can be known merely by inquiring the test result database 209, without needing to inquire the respective tested ends one by one.

When it is desirable to perform a plurality of test items on the tested end 100, the testing end 200 may schedule the tested items. Thus, the testing end 200 may further include a scheduling module 211 used for scheduling the test items for the tested end 100 when there are more than one test items, thereby generating a test item sequence for the tested end 100. Accordingly, the test execution module 207 performs the test items on the tested end 100 according to the test item sequence. Consequently, the execution sequence of the test items can be relatively flexible. If it is desirable to adopt a different method for scheduling the test items, only the scheduling module 211 needs rewriting without needing to change other modules of the testing end 200.

It can be known from the aforementioned embodiments that the application of the present invention has the following advantages. When having been stored in the hardware function table, a tested end's hardware configuration file located in a hardware function table and corresponding to a tested hardware model number can be directly based to perform a test on the tested end, thus saving the time for detecting the tested end's hardware configuration file. Further, when not being stored in the hardware function table, the tested end's hardware configuration file still can be detected for use as a base for testing the tested end. Moreover, a test web page can be used to display test information or to provide test-related operations, wherein, since a web page has high compatibility and is easily transmitted via network, the test web page can be displayed at a host of a testing end or transmitted to a remote end.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A test system, comprising:
at least one tested end having a tested hardware model number; and
a testing end establishing a connection with the tested end, the testing end comprising:
a hardware function table in which a plurality of predetermined hardware model numbers and a plurality of predetermined hardware configuration files corresponding to the predetermined hardware model numbers are stored;
a model-determining module for determining if the tested hardware model number of the tested end is one of the predetermined hardware model numbers;
a configuration-obtaining module for obtaining a tested hardware configuration file corresponding to the tested hardware model number from the predetermined hardware configuration files when the tested hardware model number is one of the predetermined hardware model numbers;
a test generation module for generating at least one test item for the tested end in accordance with the tested hardware configuration file; and
a test execution module for performing the at least one test item on the tested end.

2. The test system as claimed in claim 1, wherein the testing end further comprises:
a hardware detection module for detecting the tested end when the tested hardware model number is not one of the predetermined hardware model numbers, thereby obtaining the tested hardware configuration file of the tested end.

3. The test system as claimed in claim 2, wherein the testing end further comprises:
a configuration-writing module for writing the tested hardware configuration file obtained by the hardware detection module into the hardware function table.

4. The test system as claimed in claim 1, wherein the testing end further comprises:
a web page providing module for providing a test web page, wherein the test execution module periodically returns current test information to web page providing module when the at least one test item is performed on the tested end, thereby allowing the web page providing module to display the current test information on the test web page.

5. The test system as claimed in claim 1, wherein the testing end further comprises:
a web page providing module for providing a test web page, wherein the test generation module provides a plurality of selectable test items to the web page providing module, and the web page providing module displays the selectable test items on the test web page, thereby generating a selection signal via the test web page for selecting at least one of the selectable test item as the at least one test item for the tested end.

6. The test system as claimed in claim 1, wherein the testing end further comprises:
a test result database; and
a test result generation module for generating a test result after the at least one test item has been performed on the tested end, and storing the test result into the test result database.

7. The test system as claimed in claim 1, wherein the testing end further comprises:
a scheduling module for scheduling the test items for the tested end when there are more than one test items, thereby generating a test item sequence for the tested end, and thus the test execution module performs the test items on the tested end according to the test item sequence.

8. A test system, comprising:
at least one tested end having a tested hardware model number; and
a testing end establishing a connection with the tested end, the testing end comprising:
a hardware function table in which a plurality of predetermined hardware model numbers and a plurality of predetermined hardware configuration files corresponding to the predetermined hardware model numbers are stored;
a model-determining module for determining if the tested hardware model number of the tested end is one of the predetermined hardware model numbers;
a configuration-obtaining module for obtaining a tested hardware configuration file corresponding to the tested hardware model number from the predetermined hardware configuration files when the tested hardware model number is one of the predetermined hardware model numbers;
a hardware detection module for detecting the tested end when the tested hardware model number is not one of the predetermined hardware model numbers, thereby obtaining the tested hardware configuration file of the tested end;
a configuration-writing module for writing the tested hardware configuration file obtained by the hardware detection module into the hardware function table;
a web page providing module for providing a test web page;
a test generation module for generating at least one test item for the tested end in accordance with the tested hardware configuration file, wherein the test generation module provides a plurality of selectable test items to the web page providing module, and the web page providing module displays the selectable test items on the test web page, thereby generating a selection signal via the test web page for selecting at least one of the selectable test items as the at least one test item for the tested end;
a test execution module for performing the at least one test item on the tested end, wherein the test execution module periodically returns current test information to web page providing module when the at least one test item is performed on the tested end, thereby allowing the web page providing module to display the current test information on the test web page;
a test result database;
test result generation module for generating a test result after the at least one test item has been performed on the tested end, and storing the test result into the test result database; and
a scheduling module for scheduling the test items for the tested end when there are more than one test items, thereby generating a test item sequence for the tested end, and thus the test execution module performs the test items on the tested end according to the test item sequence.
